(19) United States
(12) Patent Application Publication
(10) Pub. No.: US 2026/0227644 A1
(43) Pub. Date: Aug. 6, 2026

(54) Lens For Wavelength Selective Scattering

(71) Applicant: HOYA Optical Labs of America, Inc., Lewisville, TX (US)

(72) Inventors: Jeffrey Brown, Ramsey, MN (US); Gregory Carlson, Ramsey, MN (US); Suvagata Tripathi, Ramsey, MN (US); Griff Altmann, Ramsey, MN (US)

(73) Assignee: HOYA Optical Labs of America, Inc., Lewisville, TX (US)

(21) Appl. No.: 19/149,508

(22) PCT Filed: Jan. 19, 2024
(86) PCT No.: PCT/US2024/012204

§ 371 Date: Jul. 18, 2025

Related U.S. Application Data
(60) Provisional application No. 63/480,878, filed on Jan. 20, 2023.
(60) Provisional application No. 63/520,306, filed on Aug. 17, 2023.

(51) Int. Cl. G02C 7/02

(52) U.S. Cl. CPC G02C 7/02; G02C 2202/06; G02C 2202/16; G02C 2202/24

(57) ABSTRACT

An ophthalmic lens for selective scattering, filtering, or absorbing of selected wavelengths for treatment of various conditions. The ophthalmic lens may include dispersed particles or dyes configured to scatter, filter, or absorb such wavelengths. The dispersed particles may be formed into a laminate or film which is incorporated into the ophthalmic lens, such as by positioning between a pair of sheets of polycarbonate. The dispersed particles may be comprised of core-shell nanoparticles having varying properties, such as core and shell sizes, so as to control the wavelengths being scattered, filtered, or absorbed.

### RELATED APPLICATIONS

This application claims benefit of and priority to U.S. Provisional Application Ser. No. 63/520,306 filed Aug. 17, 2023 entitled Lens for Wavelength Selective Scattering, and U.S. Provisional Application Ser. No. 63/480,878 filed Jan. 20, 2023 entitled Selective Wavelength Scattering Lens Article and Method, both of which are hereby incorporated herein by reference in their entireties.

### BACKGROUND OF THE INVENTION

Myopia, commonly referred to as “near-sightedness”, is a progressive eye disease with a high and increasing incidence. Myopia involves refractive error usually caused by the eyeball growing too long such that images created by the lens focus in front of, rather than on, the retina, which can cause objects far away from the eye to appear blurry.

There is evidence that myopia can be treated using wavelength-dependent visual therapy. Eye growth is known to be directed by color stimulus. The physiology of the eye indicates that longer wavelength light controls this process. When blur is detected at these longer wavelengths, the eye attempts to correct by shortening its axial growth. This corrective measure may result in an eye which senses images accurately once it has matured.

Patients undergoing a migraine attack can experience photophobia, or an abnormal sensitivity to light. It has been found that the discomfort may increase with longer (red) and/or shorter (blue) wavelengths of light. In some patients, it has been noted that light can trigger a migraine attack. Ophthalmic devices that can scatter specific wavelengths can potentially offer a solution to this problem.

In some studies, wavelength dependence of photoparoxysmal response has been observed in epilepsy patients. In such studies, a wavelength range of between 680-700 nm has been found to be primarily responsible for eliciting light sensitivity in patients. Thus, selective scattering of these wavelengths can potentially alleviate or reduce the rate of photo-induced epileptic seizure.

Additionally, seasonal affective disorder (“SAD”) is a condition in which individuals who are normally mentally healthy may experience depression during the same season each year, such as during the winter months when days are shorter. Studies have found that SAD may be amenable to treatment using light therapy. Thus, it reasonably follows that the wavelength of light used for light therapy may have an optimum value for best efficacy.

In all applications, it is desirable to modulate the optical spectrum incident on the wearer's eye. In applications for guiding the eye for proper growth (i.e., emmetropization) existing therapies have concentrated on presenting the patient with a therapeutic image, such as one in which the selected wavelengths have been blurred, which may prompt the eye to correct for the aberration as it grows. For treatment of SAD, current solutions rely on colored lights, with shorter wavelengths (e.g., green or blue) being generally filtered out.

### SUMMARY OF THE INVENTION

Disclosed herein are systems, devices, and/or methods which provide wavelength selectivity by using an ophthalmic lens as an optical filter so as to remove the need for a specially-treated image or a tailored light source.

In an example embodiment, dispersed particles or dyes may be utilized which selectively absorb or filter some wavelengths while allowing other wavelengths to pass.

In an example embodiment, such dispersed particles or dyes may comprise one or more pigments.

In an example embodiment, such dyes may comprise organic molecules.

In an example embodiment, such pigments may comprise finely-crushed minerals.

In an example embodiment, selected wavelengths may be blurred.

In an example embodiment, colored particles or dyes may be dispersed in a clear matrix.

In an example embodiment, such colored particles or dyes may be dispersed in a reactive liquid solution.

In an example embodiment, such a reactive liquid solution may be applied to an ophthalmic lens using various methods or processes.

In an example embodiment, a reactive liquid solution may be applied to an ophthalmic lens using a thin particle- or dye-loaded film.

In an example embodiment, such a thin particle- or dye-loaded film may be laminated onto or into an ophthalmic lens during production of the lens.

In an example embodiment, the size (i.e., major diameter) of the dispersed particles may be approximately 10-1,700 nm.

In an example embodiment, the dispersed particles or dyes may comprise approximately 0.2%-20% of a weight of a particle- or dye-containing laminate.

In an example embodiment, nanoparticles with sharp resonances may be dispersed in a transparent medium and laminates may be formed which may be incorporated in one or more ophthalmic lenses to induce wavelength selective scattering.

In an example embodiment, core-shell nanoparticles may be dispersed in a refractive medium.

In an example embodiment, solid particles of a known size (e.g., between about 10-1,900 nm) may be dispersed in a two-part reactive polyurethane prepolymer matrix to a concentration of about 1.5%-4.5% weight.

In an example embodiment, a reactive liquid mixture may be drawn into a thin film and formed into a laminate between two sheets of polycarbonate.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1A is a table illustrating selective wavelength scattering through controlling the radius of the core and thickness of the shell in core-shell nanoparticles.

FIG. 1B is a sectional view of a core-shell nanoparticle.

FIG. 2 is a table illustrating environmental resistance of certain laminates, reinforcing their suitability for application in ophthalmic lenses.

FIG. 3 is a table comparing various films.

FIG. 4 is a side view of a selective wavelength scattering ophthalmic lens in accordance with an example embodiment.

### DETAILED DESCRIPTION

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

For the purposes of this specification, use of the terms “about”, “around”, or “approximately” when referring to a value may be understood to mean within 5% of the stated value (either greater or lesser), inclusive.

Disclosed herein are various embodiments of an ophthalmic lens for wavelength selective scattering, absorbance, or fluorescence and methods for fabricating and/or using such a lens. Such optical filtering resulting from wavelength-dependent scattering, such as by dispersed particles and/or dyes as discussed herein, may provide various benefits. Non-limiting examples of such benefits include a diminished incidence of myopia in heavy screen users and others routinely overexposed to blue light, amelioration of migraine symptoms, reduction of light-induced seizures, and/or mitigation of seasonal depression.

An ophthalmic lens may be formed with dispersed particles or dyes that are configured to selectively absorb, scatter, and/or filter certain wavelengths, while allowing other wavelengths to pass. By way of example, longer wavelengths may be absorbed, with shorter wavelengths being allowed to pass. By way of another example, shorter wavelengths may be absorbed, scattered, or filtered, with longer wavelengths being allowed to pass. By way of yet another example, a combination of longer and shorter wavelengths may be absorbed, scattered, or filtered, with remaining wavelengths, such as between the shorter and longer wavelengths, being allowed to pass.

The ophthalmic lens may be configured such that selected wavelengths may be blurred. Colored particles or dyes may be dispersed in a clear matrix, such as by dispersing colored particles or dyes in a reactive liquid solution. Such a reactive liquid solution may include, but is not limited to, a thermally or photochemically cured composition in which dyes and/or pigments may be dispersed. The reactive liquid solution may also include various materials that are responsive in various manners to electrical and/or magnetic fields (e.g., liquid crystals).

The reactive liquid solution may be applied to the ophthalmic lens using various methods or processes, such as through use of a thin particle- or dye-loaded film or laminate. As an example, the reactive liquid solution may be applied to a surface and cured into a film with the dyes and/or particles in it. Such a particle- or dye-loaded film or laminate may be applied into or onto an ophthalmic lens, such as by being laminated into an ophthalmic lens, during production of the ophthalmic lens.

The size, such as the major diameter, of the dispersed particles may vary. By way of example, the major diameter of the dispersed particles may range from approximately 10 nm to approximately 1,700 nm. Where a laminate is formed, the dispersed particles may comprise approximately 0.2%-20% by weight of the laminate.

As an example, nanoparticles with sharp resonances may be dispersed in a transparent medium. A laminate may then be formed which may be incorporated into an ophthalmic lens, such as between two layers of substrate, to induce selective scattering of certain wavelengths.

A wide variety of dyes may be utilized in certain example embodiments. Non-limiting examples of such dyes include thymol blue, bromothymol blue, methylene blue, disperse red, indigo, cresol blue, Congo red, rhodamine 101, rhodamine B, fluorescein, coumarin 334, pyrromethene 567, and/or various other dyes known for use in connection with ophthalmic uses.

Core-shell nanoparticles may be dispersed in a refractive medium. By way of example, solid particles of a known size, such as between about 10 nm and about 1,900 nm, may be dispersed in a two-part reactive polyurethane prepolymer matrix. The concentration of such particles may vary, including a concentration of about 1.5%-4.5% weight. A reactive liquid mixture may be drawn into a thin film and then formed into a laminate between two sheets of polycarbonate.

Various laminates may be molded into a blank which may then be manufactured into a polycarbonate spectacle lens using various methods or processes. Alternatively, a cast lens may be manufactured using any of a series of suitable familiar reactive matrix materials. The manufactured lens would then have the optical filtering capabilities inherent in the starting composite material.

Specific embodiments are described below. However, it should be appreciated that any of the features from any of the embodiments can be mixed and matched with each other in any combination. Hence, the present invention should not be restricted to only these embodiments, but any broader combination(s) thereof.

In an example embodiment, an ophthalmic lens may be configured to selectively absorb, scatter, and/or filter certain undesirable wavelengths to treat various or inhibit various conditions. By way of example, such an ophthalmic lens may be utilized for treatment of myopia. As another example, such an ophthalmic lens may be utilized for prevention of migraine attacks and/or photophobia. As yet another example, such an ophthalmic lens may be utilized for alleviating or reducing photo-induced epileptic seizures. As yet another example, such an ophthalmic lens may be utilized to treat seasonal affective disorder.

The wavelengths which are filtered or scattered by the ophthalmic lens may vary in different embodiments, depending on the condition being treated. Non-limiting examples of conditions which may be treated utilizing the systems, devices, and/or methods described herein include migraine attacks, photophobia, seizures, and/or seasonal affective disorder.

For the treatment of migraine attacks and/or photophobia, longer or shorter wavelengths may be filtered, absorbed, and/or scattered, with the specific wavelengths being determined based on the patient's specific condition and treatment protocol. By way of example, longer wavelengths such as red wavelengths between about 620 nm and 700 nm may be filtered, absorbed, and/or scattered.

By way of another example, shorter wavelengths such as blue wavelengths between about 450 nm and 495 nm may be filtered, absorbed, and/or scattered. In some example embodiments, both shorter and longer wavelengths, such as wavelengths between about 620 nm and 700 nm and wavelengths between about 450 nm and 495 nm may be filtered, absorbed, and/or scattered.

For the treatment of seizures, such as for alleviating or reducing the rate of photo-induced epileptic seizures, wavelengths in the range of between about 680 nm to about 700 nm may be filtered, absorbed, and/or scattered.

For the treatment of seasonal affective disorder, shorter wavelengths may be filtered, absorbed, and/or scattered. By way of example, green wavelengths between about 500 nm and 600 nm may be filtered, absorbed, and/or scattered. By way of another example, blue wavelengths between about 450 nm and 495 nm may be filtered, absorbed, and/or scattered.

In an example embodiment, an ophthalmic lens may be formed with dispersed particles or dyes that are configured to selectively absorb, scatter, and/or filter certain wavelengths, while allowing other wavelengths to pass. The manner by which the dispersed particles or dyes are introduced into the lens may vary in different embodiments. In an example embodiment, the particles or dyes, which may be colored, may be dispersed in a clear matrix, such as by dispersion in a reactive liquid solution. The reactive liquid solution, including dispersed particles or dyes, may then be applied to the ophthalmic lens using various methods or processes, such as but not limited to use of a thin particle- or dye-loaded film laminated between layers of a substrate, such as between two layers of polycarbonate.

In an example embodiment, selective scattering of certain wavelengths may be accomplished through use of nanoparticles with sharp resonances dispersed within a transparent medium. The transparent medium with dispersed nanoparticles may be formed into a laminate which itself may be incorporated into an ophthalmic lens.

In an example embodiment, selective absorbance may be accomplished through the use of absorbing dyes. When dye-containing areas are disposed around a lens so that they align with lens portions which have corrective (and/or, if needed, plano) power, this can enhance the action of the lens to eliminate or slow the development of myopia or other refractive error in the wearer.

In an example embodiment, selective filtering, scattering, and/or absorbance may be accomplished through use of particles such as finely-crushed minerals dispersed within a transparent medium. Such finely-crushed minerals may include, but are not limited to, iron oxide, mica, silver, titanium dioxide, and the like. The transparent medium with dispersed minerals may be formed into a laminate which itself may be incorporated into an ophthalmic lens. The material type of such particles may vary in different embodiments, with properties of the particles and the material type having an effect on the types of wavelengths that may be filtered, scattered, and/or absorbed.

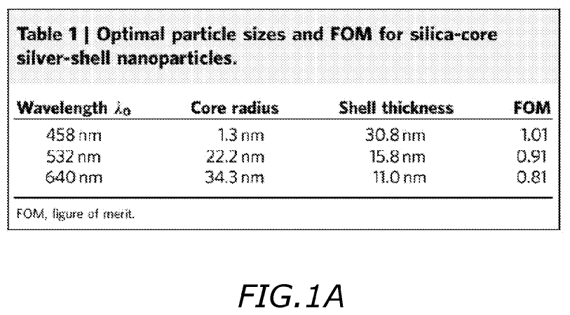

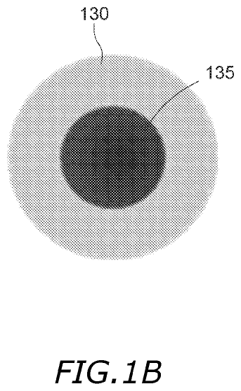

FIG. 1A is a table illustrating that, by controlling the radius of the core and thickness of the shell in core-shell nanoparticles, specific wavelengths can be scattered.

In the example embodiments illustrated in FIG. 1A, the core-shell nanoparticles may be composed of nanoparticles having a silica core and a silver shell. However, it should be appreciated that the shell and/or core of such core-shell nanoparticles may vary in different embodiments and should not be construed as limited to the configuration illustrated in FIG. 1A. Such core-shell nanoparticles may be dispersed in a refractive medium, with the refractive medium being formed into the laminate that may be applied to an ophthalmic lens.

With respect to the silica-core silver-shell nanoparticles identified in FIG. 1A, blue wavelengths of about 458 nm may be scattered by core-shell nanoparticles having a core radius of about 1.3 nm, a shell thickness of about 30.8 nm, and a figure of merit of about 1.01. Green wavelengths of about 532 nm may be scattered by core-shell nanoparticles having a core radius of about 22.2 nm, a shell thickness of about 15.8 nm, and a figure of merit of about 0.91. Red wavelengths of about 640 nm may be scattered by core-shell nanoparticles having a core radius of about 34.3 nm, a shell thickness of about 11.0 nm, and a figure of merit of about 0.81.

It should thus be appreciated that, in an example embodiment in which core-shell nanoparticles are dispersed in a medium, the core radius, shell thickness, and figures of merit of such core-shell nanoparticles may vary so as to scatter different wavelengths of light and thereby treat different conditions. By way of example, in an embodiment utilizing silica-core silver-shell nanoparticles, the core radius of such core-shell nanoparticles may vary between about 1.0 nm and 40 nm, the shell thickness of such core-shell nanoparticles may vary between about 10 nm and 35 nm, and the figure of merit of such core-shell nanoparticles may vary between about 0.75 and 1.10.

FIG. 1B is a sectional view illustrating an example embodiment of a core-shell nanoparticle comprising a core 130 and a shell 135 surrounding the core. It should be appreciated that both the core 130 and the shell 135 may be spherical, though in some example embodiments, the core 130 and/or shell 135 may not form a perfect sphere but instead may comprise various other shapes, including irregular shapes. It should also be appreciated that the respective diameters of the core 130 and the shell 135 may vary in different embodiments, and thus the respective diameters illustrated in FIG. 1B should not be construed as limiting in scope.

The core-shell nanoparticles may be dispersed within a medium, such as a transparent or refractive medium. The number of core-shell nanoparticles dispersed within the medium may vary in different embodiments. Further, the positioning of the core-shell nanoparticles within a base lens substrate may vary.

In an example embodiment, the core-shell nanoparticles may only be dispersed within portions of a lens which have corrective power, which may eliminate or slow the development of myopia or other refractive errors in the wearer. In another example embodiment, the core-shell nanoparticles may only be dispersed within portion of a lens having no corrective power (i.e., plano power). In another example embodiment, the core-shell nanoparticles may be dispersed in both corrective power and plano power portions of a lens.

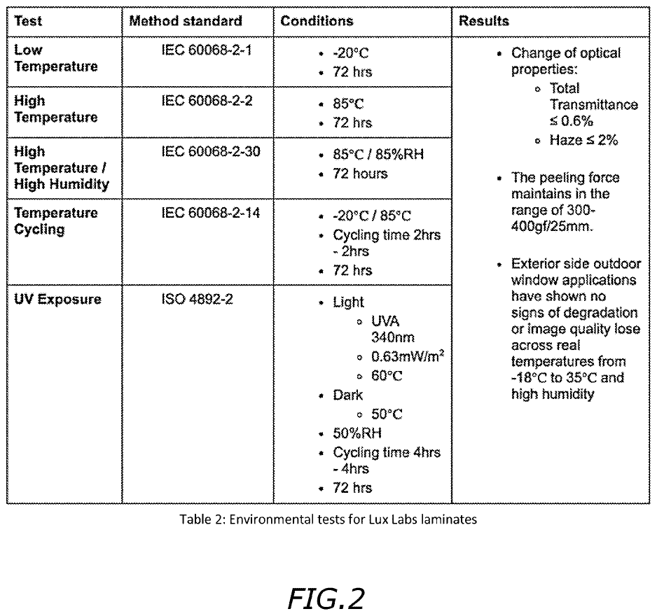

FIG. 2 is a table illustrating that such laminates including core-shell nanoparticles dispersed in a refractive medium have been shown to be environmentally resistant, and thus suitable for application in ophthalmic lenses.

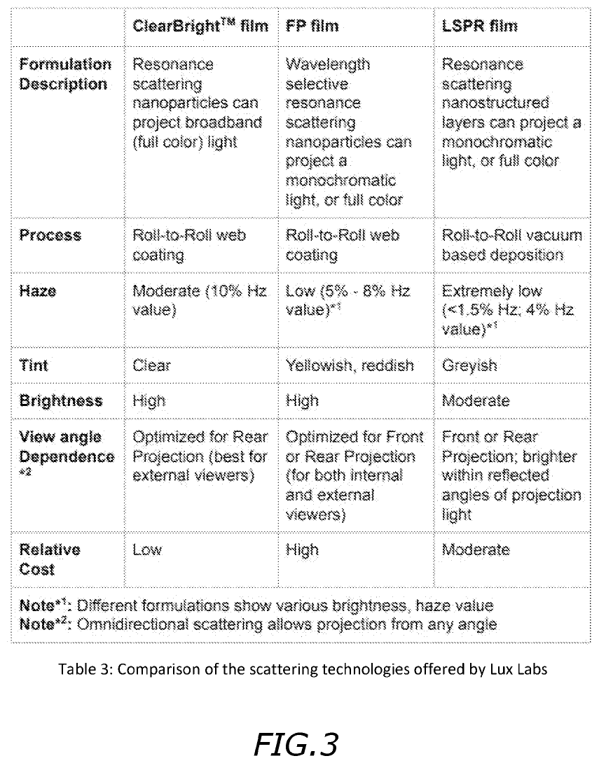

FIG. 3 is a comparison of various wavelength scattering technologies used in various displays, including front-projection films and localized plasmon resonance-based films that can project monochromatic light as well as the full spectrum.

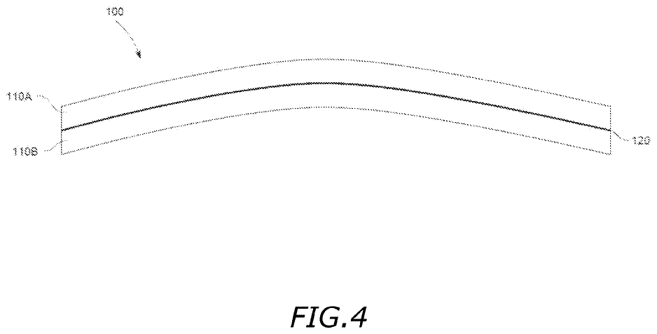

FIG. 4 is a side view of an example embodiment of an ophthalmic lens 100 configured to scatter, filter, and/or absorb certain wavelengths of light for treatment of various conditions. As shown in FIG. 4, an ophthalmic lens 100 may be formed by sandwiching a laminate or film 120 between two layers 110A, 110B of a substrate, such as polycarbonate. More specifically, it can be seen that a laminate or film 120 including dispersed particles may be positioned between a first layer 110A and a second layer 110B of polycarbonate to form the ophthalmic lens 100.

It should be appreciated that the example embodiment illustrated in FIG. 4 is merely for illustrative purposes, and thus should not be considered limiting in scope. As an example, the positioning of the laminate or film 120 with respect to the layers 110A, 110B may vary in different embodiments. While FIG. 4 illustrates that the laminate or film 120 is centrally located between the layers 110A, 110B, it should be appreciated that, in some example embodiments, the first layer 110A may have more depth than the second layer 110B, or vice versa. In other embodiments, the laminate or film 120 may be externally facing.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. An ophthalmic lens for wavelength selective filtering, fluorescence and/or scattering, comprising:
a first layer of a substrate;
a second layer of a substrate; and
a film positioned between the first layer and the second layer, the film comprising a plurality of particles or dyes configured to scatter, filter, blur, generate, or absorb selected wavelengths of light.

2. The ophthalmic lens for wavelength selective scattering of claim 1, wherein the film is comprised of the plurality of particles or dyes dispersed in a clear matrix.

3. The ophthalmic lens for wavelength selective scattering of claim 1, wherein the film is comprised of the plurality of particles or dyes dispersed in a reactive liquid solution.

4. The ophthalmic lens for wavelength selective scattering of claim 1, wherein the plurality of particles is comprised of a plurality of colored particles or dyes.

5. The ophthalmic lens for wavelength selective scattering of claim 1, wherein a major diameter of each of the plurality of particles is between 10 nm and 1,700 nm.

6. The ophthalmic lens for wavelength selective scattering of claim 1, wherein the plurality of particles comprises between 0.2% and 20% by weight of the film.

7. The ophthalmic lens for wavelength selective scattering of claim 1, wherein the plurality of particles comprises nanoparticles with sharp resonances.

8. The ophthalmic lens for wavelength selective scattering of claim 1, wherein the plurality of particles comprises core-shell nanoparticles.

9. The ophthalmic lens for wavelength selective scattering of claim 1, wherein the plurality of particles each have a size of between 10 nm and 1,900 nm.

10. The ophthalmic lens for wavelength selective scattering of claim 1, wherein the plurality of particles or dyes are dispersed in a two-part reactive polyurethane prepolymer matrix.

11. The ophthalmic lens for wavelength selective filtering and/or scattering of claim 10, wherein a concentration of the plurality of particles or dyes is between 1.5% and 4.5% of a weight of the two-part reactive polyurethane prepolymer matrix.

12. A method of fabricating an ophthalmic lens for wavelength selective scattering, comprising the steps of:
dispersing a plurality of particles or dyes in a medium; and
applying the medium to an ophthalmic lens.

13. The method of claim 12, wherein the medium is comprised of a refractive medium.

14. The method of claim 12, wherein the medium is comprised of a two-part reactive polyurethane prepolymer matrix.

15. The method of claim 12, wherein the medium is comprised of a reactive liquid solution.

16. The method of claim 12, wherein the plurality of particles or dyes are dispersed in a clear matrix.

17. The method of claim 12, wherein the step of applying the medium to the ophthalmic lens is comprised of forming the medium into a film and positioning the film between a pair of sheets of polycarbonate.

18. The method of claim 12, wherein the step of applying the medium to the ophthalmic lens is comprised of laminating the medium into the ophthalmic lens.

19. The method of claim 12, wherein the plurality of particles are comprised of nanoparticles with sharp resonances.

20. The method of claim 12, wherein the plurality of particles are comprised of core-shell nanoparticles.
